(19) United States
(12) Patent Application Publication
(10) Pub. No.: US 2008/0060913 A1
(43) Pub. Date: Mar. 13, 2008

(54) CORRECTION METHOD OF TRANSPORT AMOUNT AND MEDIUM TRANSPORT APPARATUS

(75) Inventors: Naoki Sudo, Matsumoto-shi (JP); Hirokazu Nunokawa, Matsumoto-shi (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Tokyo (JP)

(21) Appl. No.: 11/854,834

(22) Filed: Sep. 13, 2007

(30) Foreign Application Priority Data
Sep. 13, 2006 (JP) 2006-247893

(51) Int. Cl. B65G 47/26

(52) U.S. Cl. 198/459.2

(57) ABSTRACT

A correction method of a transport amount includes: obtaining transporting property information of a transport roller, which indicates a change in an actual movement amount of a medium according to a rotational position of the transport roller by detecting a movement amount of the medium while transporting the medium using the transport roller that is rotated, the transport roller being for transporting the medium by rotating, the actual movement amount of the medium, when the transport roller transports the medium by a predetermined transport amount, changing in accordance with the rotational position of the rotating transport roller; and correcting the transport amount when the transport roller further transports the medium after the transporting property information has been obtained, based on the obtained transporting property information.

### CROSS-REFERENCE TO RELATED APPLICATIONS

The present application claims priority upon Japanese Patent Application No. 2006-247893 filed on Sep. 13, 2006, which is herein incorporated by reference.

### BACKGROUND

1. Technical Field

The present invention relates to correction methods of a transport amount, and medium transport apparatuses.

2. Related Art

Medium transport apparatuses for transporting a medium, such as inkjet printers, are already well known. Some of these medium transport apparatuses are provided with a transport roller for transporting a medium by rotating, and a movement amount detecting section for detecting a movement amount of the medium.

Even when the transport roller transports a medium by a target transport amount, the actual movement amount of the medium may not agree with the target transport amount, and a so-called transport error may occur. It is known that the actual movement amount of a medium when the transport roller transports the medium by a predetermined transport amount (target transport amount) changes in accordance with a rotational position of the rotating transport roller. Thus, the transport error also changes in accordance with the rotational position.

In the cases where such a transport error occurs, the transport amount when the transport roller transports the medium needs to be corrected. More specifically, the transport amount needs to be increased or decreased from the target transport amount such that the actual movement amount of the medium agrees with the target transport amount.

A conventional medium transport apparatus is provided with a rotational position detection sensor for detecting the rotational position of the transport roller, and a storing section that stores transporting property information of the transport roller, which indicates a change in the actual movement amount according to the rotational position. The transport error is obtained using the transporting property information, based on the rotational position that has been detected by the rotational position detection sensor, and the transport amount is corrected based on the obtained transport error.

However, providing the rotational position detection sensor is too costly, and thus there has been a demand for a medium transport apparatus that can correct the transport amount as appropriate without providing the rotational position detection sensor.

It should be noted that JP-A-05-96796 is an example of related techniques.

### SUMMARY

The invention was achieved in view of the above-described problems, and it is an advantage thereof to realize a correction method of the transport amount and a medium transport apparatus that can correct as appropriate the transport amount when a transport roller transports a medium, without a rotational position detection sensor.

A primary aspect of the invention is a correction method of a transport amount as below.

A correction method of a transport amount, includes:

obtaining transporting property information of a transport roller, which indicates a change in an actual movement amount of a medium according to a rotational position of the transport roller by detecting a movement amount of the medium while transporting the medium using the transport roller that is rotated, the transport roller being for transporting the medium by rotating, the actual movement amount of the medium, when the transport roller transports the medium by a predetermined transport amount, changing in accordance with the rotational position of the rotating transport roller; and

correcting the transport amount when the transport roller further transports the medium after the transporting property information has been obtained, based on the obtained transporting property information.

Other features of the invention will become clear through the accompanying drawings and the following description.

### BRIEF DESCRIPTION OF THE DRAWINGS

For a more complete understanding of the invention and the advantages thereof, reference is now made to the following description taken in conjunction with the accompanying drawings.

FIG. 1 is a block diagram of the overall configuration of a printer 1.

FIG. 2A is a schematic view of the overall configuration of the printer 1.

FIG. 2B is a cross-sectional view of the overall configuration of the printer 1.

FIG. 3 is an explanatory diagram showing the arrangement of nozzles.

FIG. 4 is an explanatory diagram of the configuration of a transport unit 20.

FIG. 5 is a graph illustrating a change in the actual movement amount (and a transport error) of paper according to the rotational position of a transport roller 23.

FIG. 6 is a flowchart illustrating a correction method of the transport amount according to this embodiment.

FIG. 7 is a flowchart illustrating a transporting property information obtaining process.

FIG. 8 is an explanatory diagram for illustrating the detecting principle of a paper movement amount detector 55.

FIG. 9 is a graph for showing the transporting property information obtained by the transporting property information obtaining process.

FIG. 10 is an explanatory graph for illustrating a correction method of the transport amount using the transporting property information.

FIG. 11A is a diagram illustrating (a first example of) two examples regarding the time to start ejection of ink.

FIG. 11B is a diagram illustrating (a second example of) two examples regarding the time to start ejection of ink.

FIG. 12A is a (first) explanatory diagram for illustrating a superiority of a state in which the paper movement amount detector 55 is positioned on the upstream side of a head 41.

FIG. 12B is a (second) explanatory diagram for illustrating a superiority of a state in which the paper movement amount detector 55 is positioned on the upstream side of the head 41.

### DESCRIPTION OF EXEMPLARY EMBODIMENTS

At least the following matters will be made clear by the explanation in the present specification and the description of the accompanying drawings.

A correction method of a transport amount, includes:

obtaining transporting property information of a transport roller, which indicates a change in an actual movement amount of a medium according to a rotational position of the transport roller by detecting a movement amount of the medium while transporting the medium using the transport roller that is rotated, the transport roller being for transporting the medium by rotating, the actual movement amount of the medium, when the transport roller transports the medium by a predetermined transport amount, changing in accordance with the rotational position of the rotating transport roller; and

correcting the transport amount when the transport roller further transports the medium after the transporting property information has been obtained, based on the obtained transporting property information.

With this correction method of the transport amount, the transport amount when the transport roller transports a medium can be corrected as appropriate without a rotational position detection sensor.

Furthermore, the transporting property information of the transport roller, which indicates a change in the actual movement amount according to the rotational position, may be obtained by detecting the movement amount of the medium while transporting the medium using the transport roller that is rotated at least 360 degrees.

In this case, an accurate transporting property information can be obtained, and therefore exact correction can be performed.

Furthermore, the transporting property information of the transport roller, which indicates a change in the actual movement amount according to the rotational position, may be obtained,

the obtained transporting property information may be stored in a storing section, and

the transport amount when the transport roller further transports the medium after the transporting property information has been obtained may be corrected, based on the transporting property information that has been stored in the storing section.

Furthermore, the storing section may be a volatile memory.

In this case, the cost of the memory is reduced.

Further, the transporting property information of the transport roller, which indicates a change in the actual movement amount according to the rotational position may be obtained by detecting the movement amount of the medium while transporting the medium using the transport roller that is rotated, and

after the transporting property information has been obtained, ejection of ink for performing printing may be started.

In this case, ink is always precisely ejected onto a desired position.

Furthermore, the transport roller may transport the medium in a predetermined transport direction by rotating, and a movement amount detecting section for detecting the movement amount of the medium may be positioned on an upstream side, in the transport direction, of a print head for ejecting the ink for performing printing.

In this case, ink is ejected as appropriate onto the upper end or its vicinity of the medium.

A medium transport apparatus, includes:

a transport roller that transports a medium by rotating, an actual movement amount of the medium, when the transport roller transports the medium by a predetermined transport amount, changing in accordance with a rotational position of the rotating transport roller;

a movement amount detecting section for detecting a movement amount of a medium; and

a controller

that causes to obtain the transporting property information of the transport roller, which indicates a change in the actual movement amount according to the rotational position, by causing the movement amount detecting section to detect the movement amount while causing the transport roller to rotate and causing the transport roller to transport the medium, and

that corrects the transport amount when the transport roller further transports the medium after the transporting property information has been obtained, based on the obtained transporting property information.

With this medium transport apparatus, the transport amount when the transport roller transports a medium can be corrected as appropriate without a rotational position detection sensor.

Configuration of the Printer

Regarding the Configuration of the Inkjet Printer

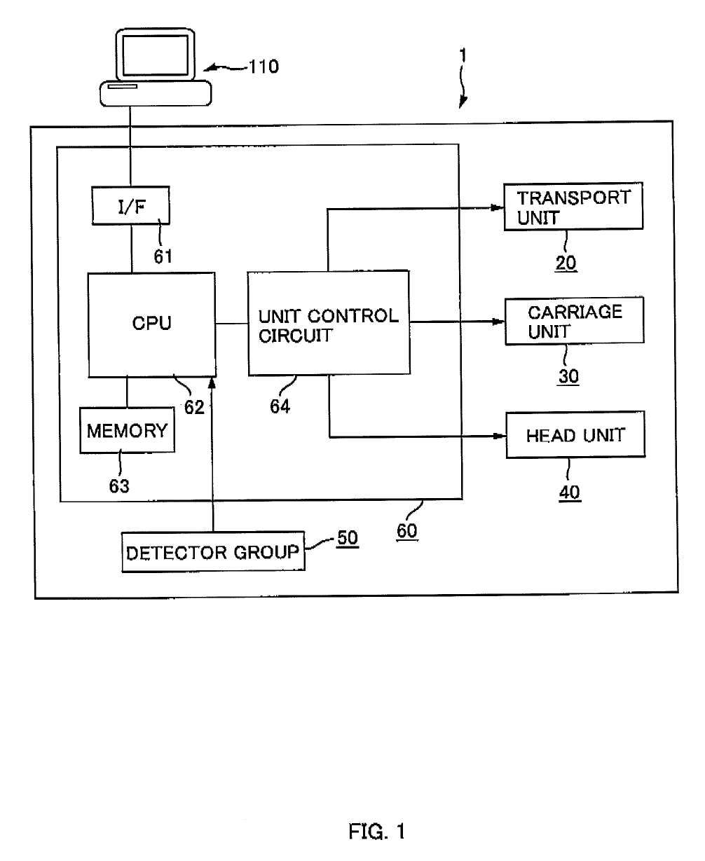

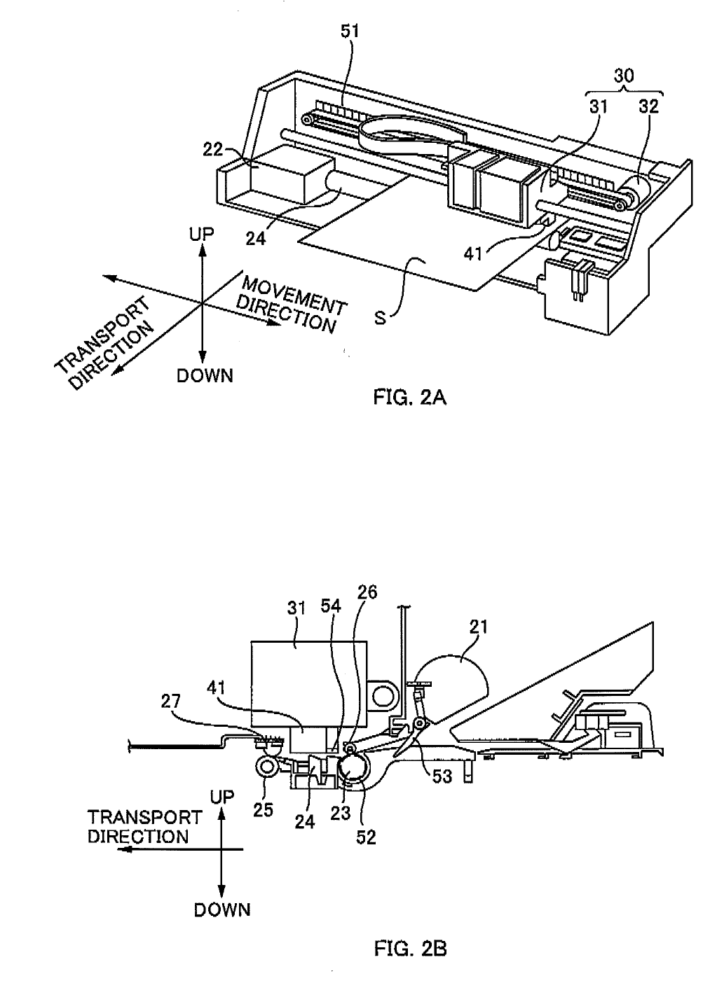

FIG. 1 is a block diagram of the overall configuration of an inkjet printer (hereinafter, also referred to as a printer 1) as an example of a medium transport apparatus. FIG. 2A is a schematic view of the overall configuration of the printer 1. FIG. 2B is a cross-sectional view of the overall configuration of the printer 1. Hereinafter, the basic configuration of the printer shall be described.

The printer 1 includes a transport unit 20, a carriage unit 30, a head unit 40, a detector group 50, and a controller 60. Having received print data from a computer 110, which is an external device, the printer 1 controls the units (the transport unit 20, the carriage unit 30, and the head unit 40) with the controller 60. The controller 60 controls the units based on the print data that has been received from the computer 110 to print an image on a paper. The detector group 50 monitors the conditions inside the printer 1, and outputs detection results to the controller 60. The controller 60 controls the units based on the detection results that have been output from the detector group 50.

The transport unit 20 is for transporting a medium (such as paper S, for example) in a predetermined transport direction. The transport unit 20 includes a paper feed roller 21, a transport motor 22 (also referred to as a PF motor), a transport roller 23, a platen 24, and a paper discharge roller 25. The paper feed roller 21 is a roller for feeding paper that has been inserted into a paper insert opening into the printer. The transport roller 23 is a roller that rotates to transport the paper S that has been fed by the paper feed roller 21 up to a printable region, and is driven by the transport motor 22. The platen 24 supports the paper S on which printing is being performed. The paper discharge roller 25 is a roller for discharging the paper S to the outside of the printer, and is provided on the downstream side of the printable region in the transport direction. The paper discharge roller 25 is rotated in synchronization with the transport roller 23. It should be noted that when the transport roller 23 transports the paper S, the paper S is held between the transport roller 23 and a driven roller 26. Accordingly, the posture of the paper S is kept stable. On the other hand, when the paper discharge roller 25 transports the paper S, the paper S is held between the paper discharge roller 25 and a driven roller 27.

The carriage unit 30 is for moving (also referred to as scanning) the head in a predetermined direction (hereinafter referred to as a movement direction), the head being an example of a print head for ejecting ink. The carriage unit 30 includes a carriage 31 and a carriage motor 32 (also referred to as a CR motor). The carriage 31 can move back and forth in the movement direction, and is driven by the carriage motor 32. Furthermore, the carriage 31 detachably holds an ink cartridge that contains ink.

The head unit 40 is for ejecting ink onto paper. The head unit 40 is provided with a head 41 having a plurality of nozzles. The head 41 is provided on the carriage 31, and thus when the carriage 31 moves in the movement direction, the head 41 also moves in the movement direction. When the head 41 intermittently ejects ink while moving in the movement direction, dot lines (raster lines) are formed on the paper in the movement direction.

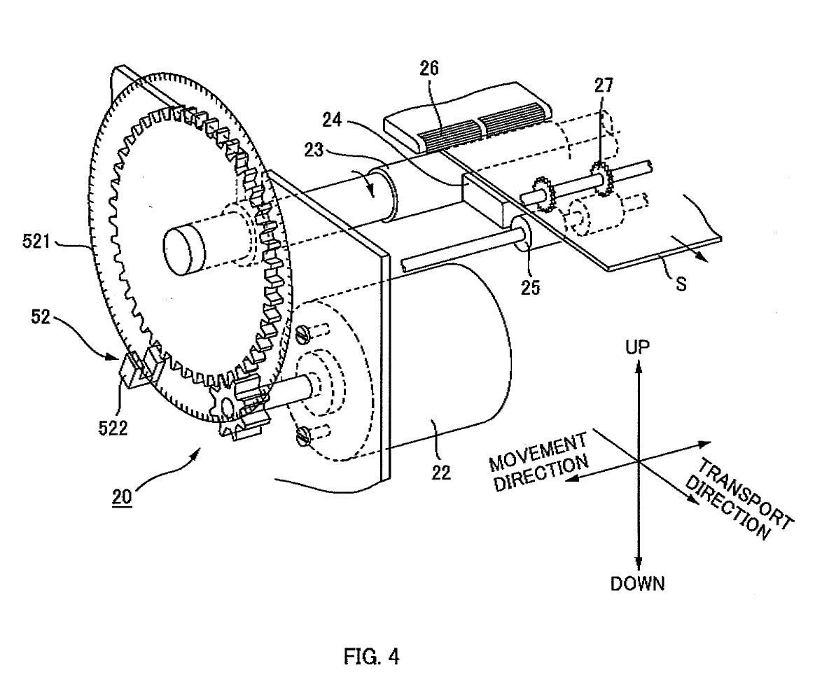

The detector group 50 includes a carriage position detector 51, a transport roller rotation amount detector 52 (see FIG. 4), a paper movement amount detector 55 (see FIG. 8, not shown in FIG. 2B) as an example of a movement amount detecting section, a paper front end position detection sensor 53, and an optical sensor 54, for example. The carriage position detector 51 detects the position of the carriage 31 in the movement direction. The transport roller rotation amount detector 52 detects the rotation amount of the transport roller 23 (described later in detail). The paper movement amount detector 55 detects the movement amount of the paper when the paper is transported by the transport roller 23 (described later in detail). The paper front end position detection sensor 53 detects the position of the front end of the paper that is being fed. The optical sensor 54 detects whether or not a paper is present, using a light-emitting section and a light-receiving section attached to the carriage 31. The optical sensor 54 can detect the width of paper by detecting the position of end portions of the paper while being moved by the carriage 31. Depending on the circumstances, the optical sensor 54 can also detect the front end (an end portion on the downstream side in the transport direction, also referred to as an upper end) and the rear end (an end portion on the upstream side in the transport direction, also referred to as a lower end) of the paper. It should be noted that the printer 1 according to this embodiment is not provided with a rotational position detection sensor for detecting the rotational position of the transport roller 23.

The controller 60 is a control unit (controller) for controlling the printer. The controller 60 includes an interface section 61, a CPU 62, a memory 63 as an example of a storing section for storing information, and a unit control circuit 64. The interface section 61 exchanges data between the computer 110, which is an external device, and the printer 1. The CPU 62 is a processing unit for controlling the entire printer. The memory 63 is for securing an area for storing programs for the CPU 62, a working area, and the like, and includes a storage element such as a RAM, which is a volatile memory, or an EEPROM, which is a non-volatile memory. The CPU 62 controls the units via the unit control circuit 64 according to the programs stored in the memory 63.

Regarding the Nozzles

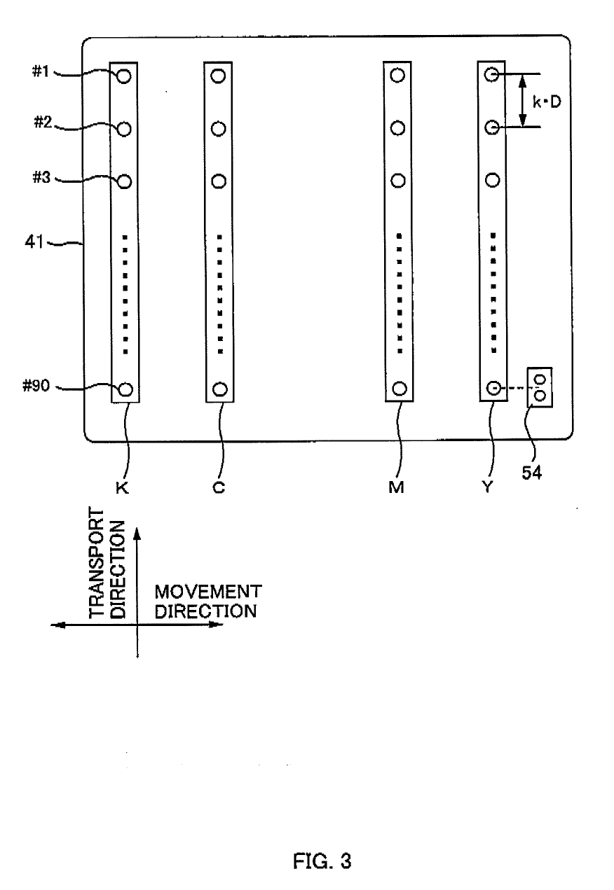

FIG. 3 is an explanatory diagram showing the arrangement of nozzles on a lower face of the head 41. A black ink nozzle group K, a cyan ink nozzle group C, a magenta ink nozzle group M, and a yellow ink nozzle group Y are formed on the lower face of the head 41. Each nozzle group is provided with 90 nozzles that are ejection openings for ejecting ink of each color.

The plurality of nozzles of each nozzle group are arranged in a row at constant intervals (nozzle pitch: k·D) in the transport direction. Herein, D is the minimum dot pitch (that is, an interval at the maximum resolution of dots formed on the paper S) in the transport direction, and k is an integer of 1 or more. For example, if the nozzle pitch is 90 dpi ( 1/90 inches) and the dot pitch in the transport direction is 720 dpi ( 1/720 inches), then k=8.

The nozzles of each nozzle group are assigned numbers (#1 to #90) that become smaller toward the downstream side. That is to say, the nozzle #1 is positioned on the downstream side of the nozzle #90 in the transport direction. It should be noted that the optical sensor 54 described above is at substantially the same position as the nozzle #90, which is on the furthest upstream side with respect to its position in the paper transport direction.

Each nozzle is provided with an ink chamber (not shown) and a piezo element. The ink chamber is constricted or expanded due to the driving of the piezo element, and ink droplets are ejected from the nozzle.

Transport Error

Regarding Paper Transport

FIG. 4 is an explanatory diagram of the configuration of the transport unit 20.

The transport unit 20 drives the transport motor 22 by a predetermined driving amount based on a transport command from the controller 60. The transport motor 22 generates a driving force in the rotational direction according to the driving amount given in the command. The transport motor 22 rotates the transport roller 23 with this driving force. More specifically, when the transport motor 22 generates a predetermined driving amount, the transport roller 23 rotates by a predetermined rotation amount. The transport roller 23 rotates by the predetermined rotation amount, thereby transporting paper by a predetermined transport amount. In this embodiment, the circumferential length of the transport roller 23 is 1 inch. Thus, for example, the transport roller 23 needs to rotate one quarter (rotate 90 degrees) in order to transport paper by ¼ inches.

Furthermore, the transport roller rotation amount detector 52 is provided in order to detect the rotation amount of the transport roller 23. The transport roller rotation amount detector 52 includes a scale 521 and a slit detecting section 522. The scale 521 has a large number of slits provided at predetermined intervals. The scale 521 is provided on the transport roller 23. That is to say, when the transport roller 23 rotates, the scale 521 rotates together therewith. When the transport roller 23 rotates, the slits of the scale 521 sequentially pass through the slit detecting section 522. The slit detecting section 522 is provided in opposition to the scale 521, and fixed to the printer main unit. The transport roller rotation amount detector 52 outputs a pulse signal each time a slit provided on the scale 521 passes through the slit detecting section 522. The slits provided on the scale 521 sequentially pass through the slit detecting section 522 in accordance with the rotation amount of the transport roller 23, and thus the rotation amount of the transport roller 23 is detected based on the output from the transport roller rotation amount detector 52.

For example, if the paper is to be transported by one inch, the controller 60 drives the transport motor 22 until the transport roller rotation amount detector 52 detects that the transport roller 23 has rotated once. In this manner, the controller 60 drives the transport motor 22 until the transport roller rotation amount detector 52 detects that the rotation amount corresponds to an amount by which transport is to be performed (target transport amount).

Regarding the Transport Error

As described above, the controller 60 drives the transport motor 22 until the transport roller rotation amount detector 52 detects that the rotation amount corresponds to an amount by which transport is to be performed (target transport amount). However, at that time, the actual movement amount of the paper may not agree with the target transport amount in the strict sense, and a so-called transport error may occur. It is known that the actual movement amount of the paper when the transport roller 23 transports the paper by a predetermined transport amount (target transport amount) changes in accordance with the rotational position of the rotating transport roller 23. Thus, the transport error also changes in accordance with the rotational position.

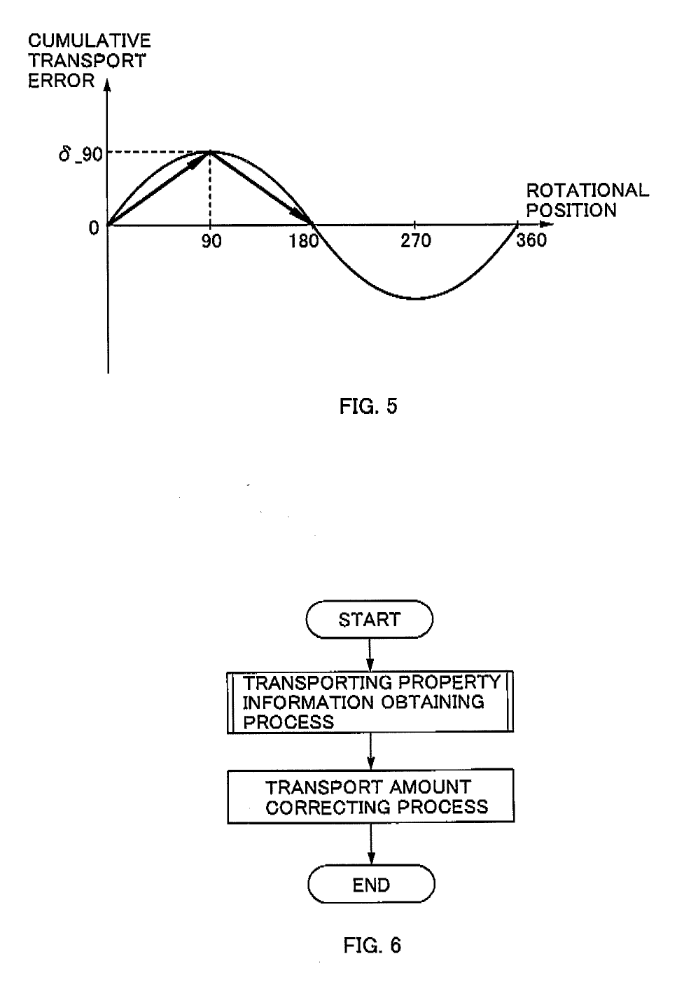

FIG. 5 is a graph illustrating a change in the actual movement amount (and a transport error) of the paper according to the rotational position of the transport roller 23. The horizontal axis indicates a rotational position of the transport roller 23, in one rotation that is given as 360 degrees, using a certain rotational position (hereinafter, referred to as a reference rotational position) of the transport roller 23 as a reference. Furthermore, the vertical axis indicates a cumulative transport error from the reference rotational position. For example, if the transport roller 23 transports paper by ¼ inches by rotating one quarter (90 degrees) from the reference rotational position, then a transport error of δ_{—}90 inches occurs, and the actual movement amount of the paper becomes ¼+δ_{—}90 inches. Furthermore, if the transport roller 23 transports the paper by ¼ inches by rotating another one quarter (90 degrees) from the position that has been reached by the rotation of one quarter (90 degrees), then a transport error of −δ_{—}90 (=0−δ_{—}90) inches occurs, and the actual movement amount of the paper becomes ¼−δ_{—}90 inches. In this manner, the transport error and the actual movement amount of paper when the transport roller 23 transports the paper by a predetermined transport amount (target transport amount) change in accordance with the rotational position of the rotating transport roller 23. It should be noted that the graph of the cumulative transport error shown in FIG. 5 is substantially a sine curve, although it slightly varies, depending on a value of the coefficient of friction when the transport roller 23 is in contact with the back face of paper, or the production precision of the transport roller 23.

Correction Method of the Transport Amount

General Outline

As described above, even when the transport roller transports paper by a target transport amount, the actual movement amount of the paper may not agree with the target transport amount, and a so-called transport error may occur. It is known that the actual movement amount of paper when the transport roller transports the paper by a predetermined transport amount (target transport amount) changes in accordance with a rotational position of the rotating transport roller, and thus the transport error also changes in accordance with the rotational position.

In the case where such a transport error occurs, the transport amount when the transport roller transports the paper needs to be corrected. More specifically, the transport amount needs to be increased or decreased from the target transport amount such that the actual movement amount of the paper agrees with the target transport amount.

A conventional printer is provided with a rotational position detection sensor for detecting the rotational position of the transport roller, and a memory that stores transporting property information of the transport roller (such as the graph shown in FIG. 5, for example), which indicates a change in the actual movement amount according the rotational position. The transport error is obtained using the transporting property information, based on the rotational position that has been detected by the rotational position detection sensor, and the transport amount is corrected based on the obtained transport error.

However, providing the rotational position detection sensor is too costly, and thus there has been a demand for a printer that can correct the transport amount as appropriate without providing a rotational position detection sensor.

The printer 1 according to this embodiment is not provided with a rotational position detection sensor. In the printer 1, a correction method of the transport amount is performed that can correct as appropriate the transport amount when the transport roller 23 transports paper, without the rotational position detection sensor.

FIG. 6 is a flowchart illustrating the correction method of the transport amount according to this embodiment. As shown in this flowchart, the correcting method can be divided into: transporting property information obtaining process of obtaining transporting property information of a transport roller 23, which indicates a change in an actual movement amount of a medium according to a rotational position of the transport roller by detecting a movement amount of the paper while transporting the paper using the transport roller 23 that is rotated; and transport amount correcting process of correcting the transport amount when the transport roller 23 further transports the paper after the transporting property information has been obtained, based on the obtained transporting property information.

In the following sections, both processes shall be described in more detail. It should be noted that various operations of the printer 1 described below (in the following sections) are mainly realized by the controller 60 inside the printer 1. More specifically, in this embodiment, the operations are realized by the CPU 62 executing programs stored in the memory 63. These programs are constituted by codes for performing various operations described below.

Transporting Property Information obtaining Process

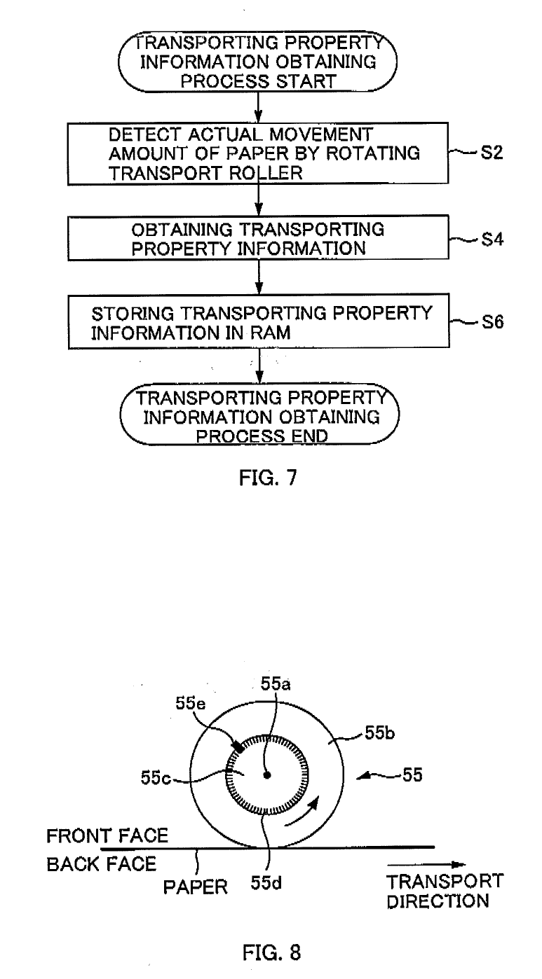

FIG. 7 is a flowchart illustrating the transporting property information obtaining process. The transporting property information obtaining process is started taking, as a trigger, the event that the printer 1 receives a print command (print data) from the computer 110, for example.

First, the controller 60 rotates the transport roller 23 in order to transport a paper. While transporting the paper, the paper movement amount detector 55 is caused to detect the actual movement amount of the paper (step S2).

FIG. 8 is an explanatory diagram for illustrating the detecting principle of the paper movement amount detector 55. The paper movement amount detector 55 is provided with a roller section 55b that rotates about a rotational shaft 55a while being in contact with the front face of paper, in accordance with movement of the paper along the transport direction, a scale 55c that rotates together with the roller section 55b and that has a large number of slits 55d provided at predetermined intervals, and a slit detecting section 55e for detecting the slits 55d. When the paper moves along the transport direction, the scale 55c rotates together with the roller section 55b. The paper movement amount detector 55 outputs a pulse signal each time the slit 55d provided on the scale 55c passes through the slit detecting section 55e. The movement amount of the paper is detected based on (the number of) the pulse signals.

The paper movement amount detector 55 is provided so as to be in contact with an end portion in the width direction of the paper, and is biased by a biasing member (not shown) toward the paper such that the paper movement amount detector 55 is in contact with the paper as appropriate. Furthermore, since the paper movement amount detector 55 is provided so as to be in contact (not with the back face, but) with the front face of the paper, the detection precision is very high.

In this embodiment, the operation of S4 is performed until the transport roller rotates for one round (360 degrees). Then, as the transporting property information, which indicates a change in the actual movement amount according to the rotational position, the graph shown in FIG. 5 is obtained (step S4). That is, the controller 60 performs the operation in step S2, and calculates a transport error (that is, a value obtained by subtracting the transport amount from the actual movement amount of the paper). Then, a graph showing a corresponding relationship between a rotational position and a cumulative transport error of the transport roller 23 is made for one round of the transport roller.

Then the controller 60 stores the obtained transport amount property information (graph in FIG. 5) in a memory 63, more specifically, in RAM, which is a volatile memory (step S6).

Transport Amount Correcting Process

When the above described transport property information obtaining process ends, the transporting property information that is used when correcting the transport amount in the transport amount correcting process is obtained, and not only this, but also a rotational position of the transport roller 23 is specified.

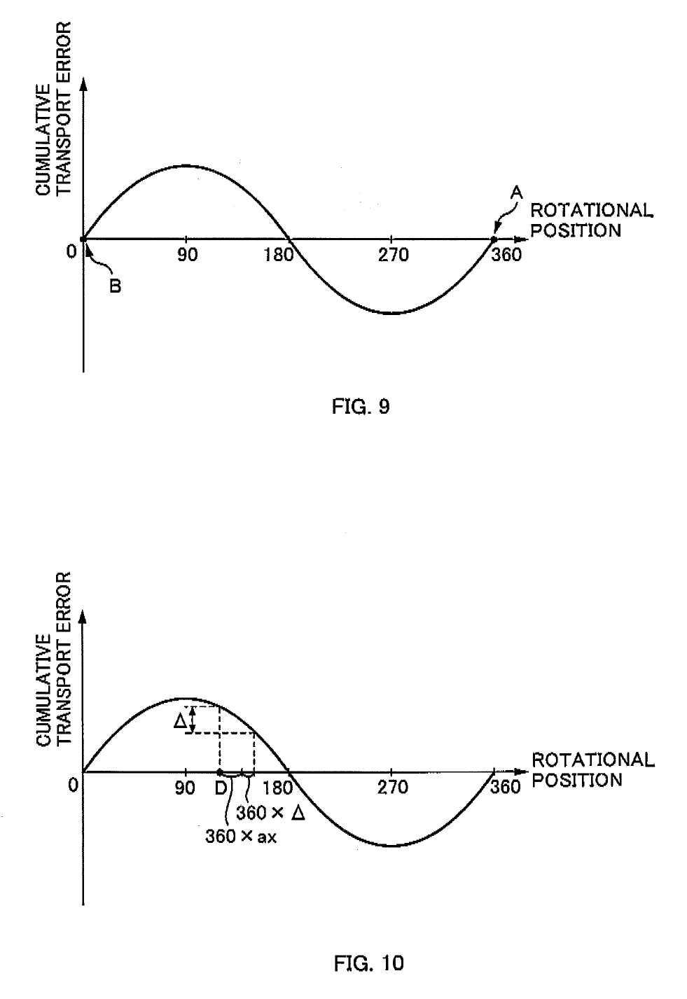

FIG. 9 is a graph showing the transporting property information obtained by the transporting property information obtaining process. When the transporting property information obtaining process ends, of course the rotational position of the transport roller 23 is at a position shown by point A in the graph. That is, when the transporting property information obtaining process is performed, the rotational position A (the position shown by point A is equal to a position shown by point B, so it can be called a rotational position B) at the time when the transporting property information obtaining process ends is automatically specified.

The subsequent rotational positions are always known (in other words, it is always possible to know a point on the X-axis in FIG. 9 at which a current rotational position is present), because all of the transport amounts when the transport roller 23 subsequently transports the paper are known. Then, after the transporting property information is obtained, the transport amount when the transport roller 23 transports the paper can be corrected appropriately (described in detail later).

If the controller 60 is to transport the paper by ax inches, first, a correction value α is obtained. Then, the transport roller 23 is rotated by 360×(ax+α) degrees in order to transport the paper by ax+α inches.

Next, the manner in which the correction value α is obtained shall be described with reference to FIG. 10. FIG. 10 is an explanatory graph for illustrating a correction method of the transport amount using the transporting property information. Referring to the graph in FIG. 10, the controller 60 obtains a value Δ at which the actual movement amount of paper is ax inches when the paper is transported by ax+Δ inches. More specifically, a value Δ is obtained via numerical analysis and the like (using the value Δ) with reference to the graph in FIG. 10, the value Δ satisfying the condition that a transport error of −Δ inches occurs due to a transport by ax+Δ inches (rotation by 360×(ax+Δ) degrees) from a known current rotational position (this rotational position is obtained based on a rotational position A (B) that has been automatically specified at the end of the transporting property information obtaining process, and is indicated by the symbol D in FIG. 10). This value A serves as the above-mentioned correction value α.

It should be noted that in this embodiment, also when the paper is transported by the corrected transport amount, the paper movement amount detector 55 detects the actual movement amount of the paper.

Considering that the transport amount is corrected as described above such that the actual movement amount of the paper agrees with the target transport amount, the actual movement amount of the paper detected by the paper movement amount detector 55 is to agree with the target transport amount. However, actually, there is a possibility that a slight difference appears therebetween.

Considering this point, in this embodiment, the difference dif (when the transport amount is given as ax, and the actual movement amount of the paper detected by the paper movement amount detector 55 is given as bx, then the difference dif=bx−ax) is calculated. The calculation results are taken into account when the transport amount is corrected next time. For example, if a value of the difference dif is dif1 in the n^{th} transport, then paper is transported in the n+1^{th} transport by a transport amount that is smaller by dif1 than a corrected transport amount (such as ax+α inches, as described above). Also at that time, after the actual movement amount of the paper is detected, the difference dif is calculated (the calculated value is given as dif2), and paper is transported in the n+2^{th} transport by a transport amount that is smaller by dif2 than a corrected transport amount.

Effectiveness of the Correcting Method

As described above, in this embodiment, there are performed the transporting property information obtaining process of obtaining transporting property information of a transport roller 23, which indicates a change in an actual movement amount of a medium according to a rotational position of the transport roller by causing the paper movement amount detector 55 to detect a movement amount of the paper while transporting the paper using the transport roller 23 that is rotated, and a transport amount correcting process of correcting the transport amount when the transport roller 23 further transports the paper after the transporting property information has been obtained, based on the obtained transporting property information. Thus, even without a rotational position detecting sensor, the effect that the transport amount when the transport roller 23 transports the paper can be appropriately corrected is achieved.

Further, since the transporting property information obtaining process is included in the correction method, even if the transporting property of the transport roller 23 changes by such as abrasion of the transport roller 23, correcting of the transport amount using the transporting property information, which indicates the latest transporting property, is performed, and the transport amount can be corrected exactly.

Regarding the Time to Start Ejection of Ink

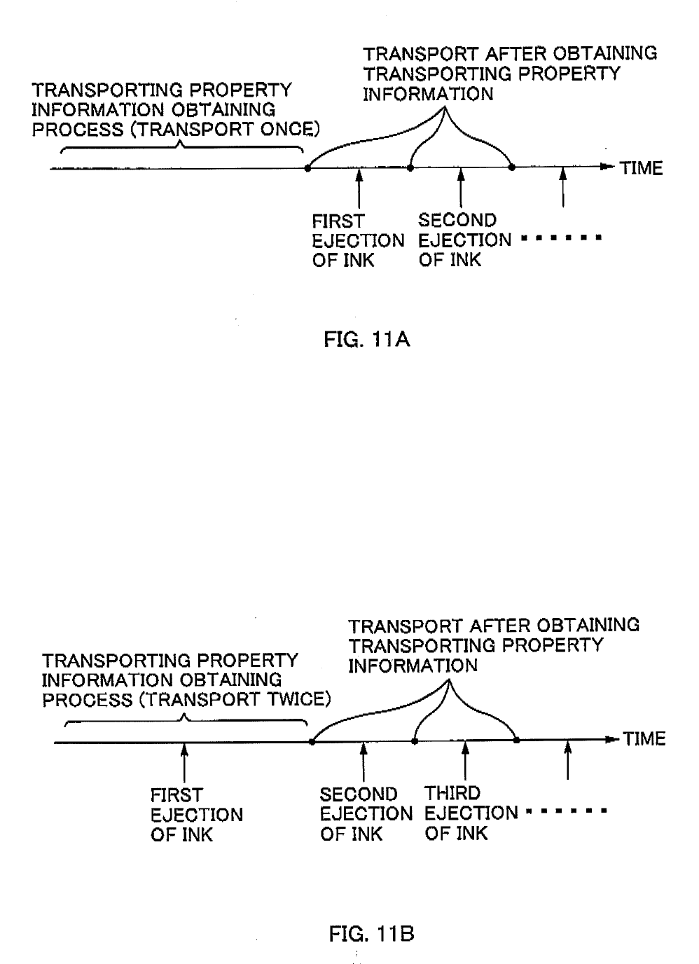

FIGS. 11A and 11B are diagrams illustrating two examples regarding the time to start ejection of ink. As described above, and as shown in FIGS. 11A and 11B, the transporting property information obtaining process is started taking, as a trigger, the event that the printer 1 receives a print command (print data) from the computer 110, for example, and paper transport (step S2 in the flowchart in FIG. 7) is performed in this process. Then, in paper transport after the transporting property information is obtained in the transporting property information obtaining process, the transport amount can be corrected.

FIG. 11A illustrates an example according to this embodiment, in which the head 41 starts ejection of ink for performing printing after the transporting property information is obtained. After the transporting property information is obtained, the transport amount can be corrected, and thus transport precision in paper transport becomes high. On the other hand, before the transporting property information is obtained, the transport amount is not corrected, and thus transport precision in paper transport is low. Accordingly, the example in FIG. 11A in which the head 41 starts ejection of ink for performing printing after the transporting property information is obtained is preferable in that ink is always precisely ejected onto a desired position.

However, there is no limitation to this, and an example as shown in FIG. 11B is also conceivable. FIG. 11B illustrates an example that is different from this embodiment, in which the head 41 starts ejection of ink for performing printing before the transporting property information is obtained. In this example, paper transport by rotating the transport roller 23 for one rotation in the transporting property information obtaining process is divided into a plurality of time (twice in the example in FIG. 11B). Then, ejection of ink is started in between the transports (after the first transport has finished and before the second transport has started).

In particular, in the case of an example as shown in FIG. 11A, the paper movement amount detector 55 is preferably positioned on the upstream side of the head 41 in the transport direction.

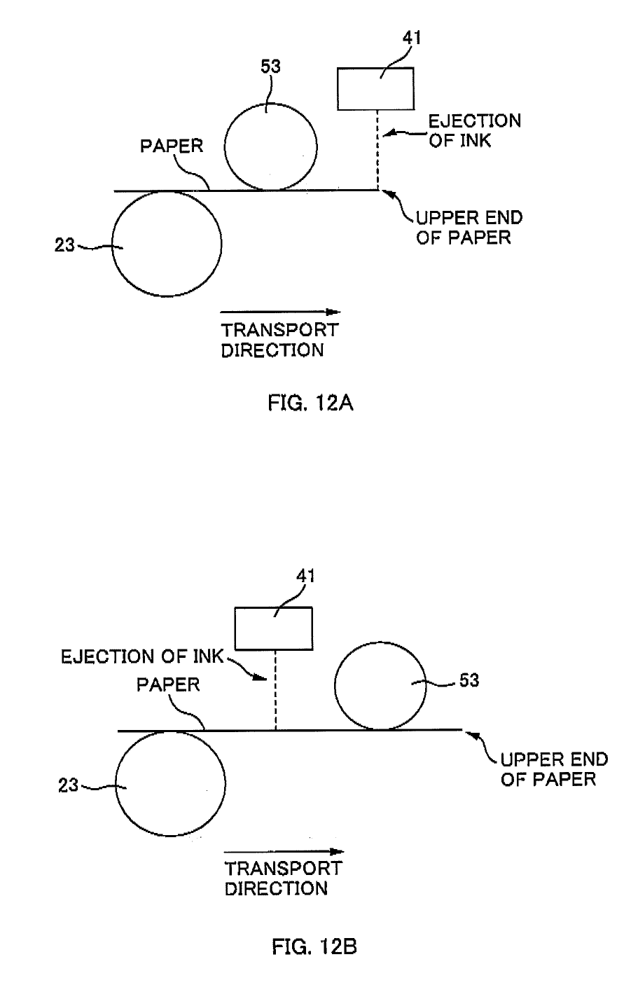

FIGS. 12A and 12B are explanatory diagrams for illustrating a superiority of a state in which the paper movement amount detector 55 is positioned on the upstream side of the head 41. FIG. 12A shows a state in which the paper movement amount detector 55 is positioned on the upstream side of the head 41 (superior example). FIG. 12B shows a state in which the paper movement amount detector 55 is positioned on the downstream side of the head 41 (non-superior example).

As described above, when paper is transported in the transporting property information process, the paper movement amount detector 55 detects the actual movement amount of the paper, and thus the upper end of the paper needs to have reached the paper movement amount detector 55. Thus, when ejection of ink is started after the transporting property information process has finished the upper end of the paper is positioned on the downstream side of the paper movement amount detector 55 in the transport direction as shown in FIGS. 12A and 12B.

Herein, if the paper movement amount detector 55 is positioned on the downstream side of the head 41 as shown in FIG. 12B, the upper end of the paper has passed by the head 41 and is significantly away therefrom in the transport direction when ejection of ink is started, and thus the ink cannot be ejected onto the upper end or its vicinity of the paper. On the other hand, if the paper movement amount detector 55 is positioned on the upstream side of the head 41 as shown in FIG. 12A, the upper end of the paper has not passed by the head 41 in the transport direction (or even if the upper end has passed by the head 41, the degree is slight) when ejection of ink is started, and thus the ink is ejected as appropriate onto the upper end or its vicinity of the paper (this superiority is more effective in particular in borderless printing in which printing is performed on the entire surface of the paper).

### Other Embodiments

The correction method of the transport amount and the like according to the invention were described by way of the foregoing embodiment, but the foregoing embodiment of the invention is merely for the purpose of elucidating the invention and is not to be interpreted as limiting the invention. The invention can of course be altered and improved without departing from the gist thereof and equivalents are intended to be embraced therein.

In the foregoing embodiment, the inkjet printer provided with the print head for ejecting ink was described as an example of a medium transport apparatus, but the invention can be applied also to other printers such as dot impact printers and thermal transfer printers. In addition to printers, the invention can be applied to any apparatus for transporting a medium (such as color filter manufacturing apparatuses, dyeing apparatuses, fine processing apparatuses, semiconductor manufacturing apparatuses, surface processing apparatuses, three-dimensional shape forming machines, liquid vaporizing apparatuses, organic EL manufacturing apparatuses (in particular, macromolecular EL manufacturing apparatuses), display manufacturing apparatuses, film formation apparatuses, and DNA chip manufacturing apparatuses).

Further, in the above embodiment, the controller 60 causes to obtain the transporting property information of the transport roller 23, which indicates a change in the actual movement amount according to the rotational position, by causing the paper movement amount detector 55 to detect the movement amount of the medium while transporting the paper using the transport roller 23 that is rotated at least 360 degrees. However, it is not limited thereto, and when obtaining the transporting property information, the transport roller 23 can be rotated only less than 360 degrees.

In the example of rotating the transport roller 23 only less than 360 degrees, there can be given an example of making the transporting property information for one round by obtaining the transporting property information for a half round (left half of the graph shown in FIG. 9 and the like) by rotating the transport roller 23 only 180 degrees, and inversing the obtained transporting property information (left half of the graph shown in FIG. 9 and the like), for the rest of the half round (180 to 360 degrees). However, in the example according to the above embodiment of rotating the transport roller 23 at least 360 degrees, an accurate transporting property information can be obtained, and thus is preferable because it enables an exact correction to be performed.

Furthermore, in the foregoing embodiment, the transport amount when the transport roller 23 further transports the paper after the transporting property information is obtained was corrected by the controller 60 based on the transporting property information stored in the memory 63, by obtaining the transporting property information and storing the obtained transporting property information in the memory 63, but there is no limitation to this. For example, the memory for storing the transport amount may be a nonvolatile memory (for example, EEPROM).

In the above embodiment, since the transporting property information is obtained as required such as immediately before printing, when the power supply of the printer is cut off, it is not necessary to hold the transporting property information in the memory. Therefore, it is possible to store the transporting property information in a volatile memory (and not a nonvolatile memory), and in this way, it is possible to reduce the cost of the memory.

What is claimed is:

1. A correction method of a transport amount, comprising:
obtaining transporting property information of a transport roller, which indicates a change in an actual movement amount of a medium according to a rotational position of the transport roller by detecting a movement amount of the medium while transporting the medium using the transport roller that is rotated, the transport roller being for transporting the medium by rotating, the actual movement amount of the medium, when the transport roller transports the medium by a predetermined transport amount, changing in accordance with the rotational position of the rotating transport roller; and
correcting the transport amount when the transport roller further transports the medium after the transporting property information has been obtained, based on the obtained transporting property information.

2. A correction method of a transport amount according to claim 1,
wherein the transporting property information of the transport roller, which indicates a change in the actual movement amount according to the rotational position, is obtained by detecting the movement amount of the medium while transporting the medium using the transport roller that is rotated at least 360 degrees.

3. A correction method of a transport amount according to claim 1,
wherein the transporting property information of the transport roller, which indicates a change in the actual movement amount according to the rotational position, is obtained,
the obtained transporting property information is stored in a storing section, and
the transport amount when the transport roller further transports the medium after the transporting property information has been obtained is corrected, based on the transporting property information that has been stored in the storing section.

4. A correction method of a transport amount according to claim 3,
wherein the storing section is a volatile memory.

5. A correction method of a transport amount according to claim 1,
wherein the transporting property information of the transport roller, which indicates a change in the actual movement amount according to the rotational position is obtained by detecting the movement amount of the medium while transporting the medium using the transport roller that is rotated, and
after the transporting property information has been obtained, ejection of ink for performing printing is started.

6. A correction method of a transport amount according to claim 5,
wherein the transport roller transports the medium in a predetermined transport direction by rotating, and
a movement amount detecting section for detecting the movement amount of the medium is positioned on an upstream side, in the transport direction, of a print head for ejecting the ink for performing printing.

7. A medium transport apparatus, comprising:
a transport roller that transports a medium by rotating, an actual movement amount of the medium, when the transport roller transports the medium by a predetermined transport amount, changing in accordance with a rotational position of the rotating transport roller;
a movement amount detecting section for detecting a movement amount of a medium; and
a controller
that causes to obtain the transporting property information of the transport roller, which indicates a change in the actual movement amount according to the rotational position, by causing the movement amount detecting section to detect the movement amount while causing the transport roller to rotate and causing the transport roller to transport the medium, and
that corrects the transport amount when the transport roller further transports the medium after the transporting property information has been obtained based on the obtained transporting property information.
